(19) United States
(12) Patent Application Publication
(10) Pub. No.: US 2009/0259538 A1
(43) Pub. Date: Oct. 15, 2009

(54) Network-based rebate system

(76) Inventors: Kevin Brent Miller, San Carlos, CA (US); Shruti Chugh, San Jose, CA (US); Deepa Sivaramakrishnan, San Jose, CA (US); Cory S. Williamson, Palo Alto, CA (US); Noah Neiman, Palo Alto, CA (US)

Correspondence Address: TECHNOLOGY & INNOVATION LAW GROUP, PC, ATTN: 101, 19200 STEVENS CREEK BLVD., SUITE 240, CUPERTINO, CA, 95014, US

(21) Appl. No.: 12/103,207

(22) Filed: Apr. 15, 2008

(51) Int. Cl. G06Q 10/00; G06Q 30/00; G06Q 20/00

(52) U.S. Cl. 705/14; 705/30

(57) ABSTRACT

An online rebate system is disclosed. The online rebate system allows purchasers of products to gain nearly immediate determinations of whether they are eligible for any rebates. In one embodiment, a purchaser can provide a transaction identifier for a prior purchase transaction to the online rebate system, and then the online rebate system can examine the transaction, including the products purchased, to determine in near real-time whether the purchaser is entitled to a rebate. If the purchaser is entitled to a rebate, payment for such rebate can be automatically initiated. In the event the purchaser is not entitled to a rebate, the purchaser can be so notified.

### BACKGROUND OF THE INVENTION

1. Field of the Invention

The present invention relates to rebates for purchases and, more particularly, to customer-initiated rebates for prior purchases.

2. Description of the Related Art

Manufacturers and retailers have used rebates for many years to provide incentives for customers to make purchases. Typically, a rebate is offered to customers who purchase a particular product within a given time frame. Conventionally, a purchaser would be given a rebate form at the place of purchase. The purchaser would thereafter decide whether or not to submit a request for a rebate. The conventional rebate submission requires the purchaser to complete the rebate form and mail it along with proof of purchase to the manufacturer or retailer. Unfortunately, however, the conventional rebate submission process is not only overly burdensome to purchasers but also slow and unpredictable. Many purchasers avoid submission of rebate claims because of the burdens involved. Even if purchasers endure the rebate submission process, purchasers will wait many weeks or months for a response. A rebate submission will often be denied because all the required information, forms or attachments were not included. Even in the case where a rebate submission is approved, it still takes weeks or months to receive the rebate, which can be in the form of a rebate check, coupon or gift card.

Manufacturers and retailers also must themselves (or by contract with third-parties) process rebate submissions. However, processing conventional mailed-in rebate submissions is difficult, labor intensive and expensive. Manufacturers and retailers also have little data that provides insight into status of rebates.

Thus, there is a need for improved approaches to processing rebates.

### SUMMARY OF THE INVENTION

The invention pertains to an online rebate system. The online rebate system allows purchasers of products to gain nearly immediate determinations of whether they are eligible for any rebates. In one embodiment, a purchaser can provide a transaction identifier for a prior purchase transaction to the online rebate system, and then the online rebate system can examine the transaction, including the products purchased, to determine in near real-time whether the purchaser is entitled to a rebate. If the purchaser is entitled to a rebate, payment for such rebate can be automatically initiated. In the event the purchaser is not entitled to a rebate, the purchaser can be so notified.

The invention can be implemented in numerous ways, including as a method, system, device, apparatus (including computer readable medium). Several embodiments of the invention are discussed below.

As a computer-implemented method for processing rebates, one embodiment of the invention can, for example, include at least: receiving an online rebate request identifying a prior purchase transaction, the rebate request being associated with a rebate requester; determining whether the prior purchase transaction is eligible for a rebate; and notifying the rebate requester that the rebate request has been approved if it is determined that the prior purchase transaction is eligible for a rebate.

As a computer-implemented method for electronically processing a rebate claim, one embodiment of the invention can, for example, include at least: receiving an account login request for a rebate requester operating a client machine; validating the rebate requester in response to the account login request; sending a contact information page for display at the client machine, the contact information facilitating acquisition of contact information for use in processing the rebate claim; sending a retail channel identification page for display at the client machine, the retail channel identification page facilitating acquisition of an indication of a retail channel used in a purchase transition for which a rebate is sought; sending a purchase identification page for display at the client machine, the purchase identification page facilitating acquisition of at least one purchase identification indicia for the purchase transition for which a rebate is sought; accessing transaction data associated with the at least one purchase identification indicia for the purchase transaction; determining whether the purchase transaction is eligible for at least one rebate based on at least the transaction data for the purchase transaction; and sending a rebate approval page for display at the client machine if it is determined that the purchase transaction is eligible for at least one rebate. Optionally, the computer-implemented method can further provide an escalation path when the purchase transaction is deemed ineligible.

As an online rebate processing system, one embodiment of the invention can, for example, include at least: a web interface configured to permit a purchaser to identify a prior purchase transaction and request a rebate payment; a transaction database configured to store sales transaction data for products; and a rebate management system operatively connected to the transaction database and the web interface. The rebate management system can be configured to process the request for rebate payment. The rebate management system can retrieve corresponding sales transaction data for the prior purchase transaction and thereafter process the request for rebate payment in accordance with predetermined rebate rules and the retrieved sales transaction data to determine whether the request for rebate payment is approved.

As a computer readable storage medium including at least executable computer program code tangibly stored thereon for processing rebates, one embodiment of the invention can, for example, include at least: computer program code for receiving an online rebate request identifying a prior purchase transaction, the rebate request being associated with a rebate requester; computer program code for determining whether the prior purchase transaction is eligible for a rebate; and computer program code for notifying the rebate requester that the rebate request has been approved if it is determined that the prior purchase transaction is eligible for a rebate.

Other aspects and embodiments of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, in which:

FIG. 1 is a block diagram of a rebate system according to one embodiment of the invention.

FIG. 2 is a flow diagram of an online rebate process according to one embodiment of the invention.

FIG. 3 is a flow diagram of a client-side rebate process according to one embodiment of the invention.

FIGS. 4A-4C are block diagrams of a server-side rebate process according to one embodiment of the invention.

FIG. 5 is a flow diagram of a rebate eligibility process according to one embodiment of the invention.

### DETAILED DESCRIPTION OF THE INVENTION

The invention pertains to an online rebate system. The online rebate system allows purchasers of products to gain nearly immediate determinations of whether they are eligible for any rebates. In one embodiment, a purchaser can provide a transaction identifier for a prior purchase transaction to the online rebate system, and then the online rebate system can examine the transaction, including the products purchased, to determine in near real-time whether the purchaser is entitled to a rebate. If the purchaser is entitled to a rebate, payment for such rebate can be automatically initiated. In the event the purchaser is not entitled to a rebate, the purchaser can be so notified.

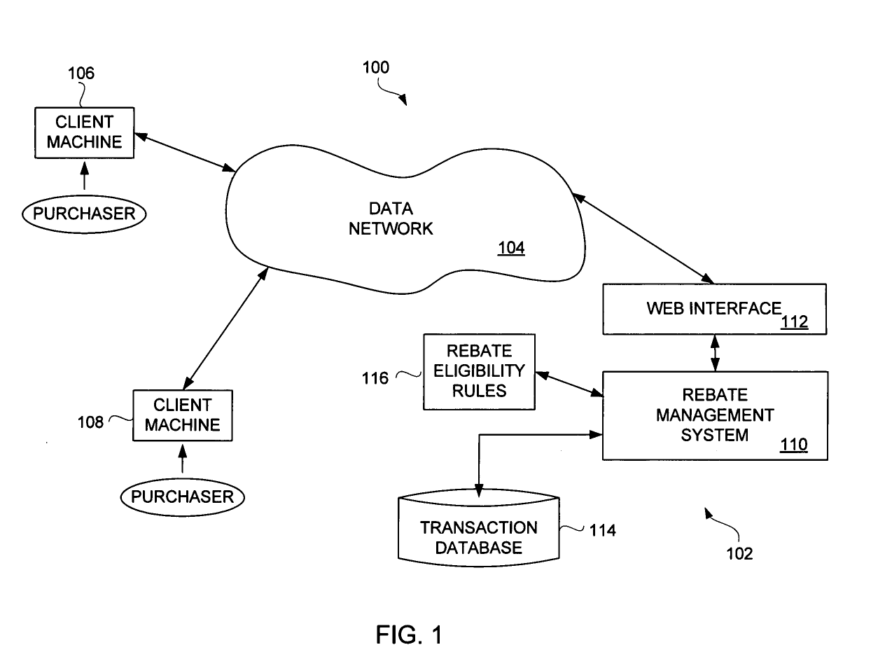

Embodiments of the invention are discussed below with reference to FIGS. 1-5. However, those skilled in the art will readily appreciate that the detailed description given herein with respect to these figures is for explanatory purposes as the invention extends beyond these limited embodiments.

FIG. 1 is a block diagram of a rebate system 100 according to one embodiment of the invention. The rebate system 100 includes an online rebate processing system 102. The rebate system 100 also makes use of a data network 104 as well as client machines 106 and 108.

The rebate system 100 enables purchasers of one or more products from a business (e.g., company) to submit a rebate request online. For example, a purchaser who has previously purchased one more products can utilize the client machine 106 or 108 to access the online rebate processing system 102 via the data network 104 and thereby submit a rebate request.

In one embodiment, the data network 104 can represent a global network of interconnected computers, such as the Internet. Advantageously, the purchaser can utilize any client machine with a network browser having access to the data network 104 to submit a rebate request to the online rebate processing system 102.

The online rebate processing system 102 includes a rebate management system 110. The rebate management system 110 manages the overall processing of rebate requests that are submitted to the online rebate processing system 102 by purchasers via one or more client machines (e.g., client machines 106, 108). The online rebate processing system 102 includes a web interface 112. The web interface 112 is controlled by the rebate management system 102 to cause data to be presented to the purchasers at the client machines or to receive data entered by the purchasers at the client machines.

The online rebate processing system 102 further includes a transaction database 114. The transaction database 114 stores transaction data for purchases that have been made with respect to products of interest. In one embodiment, the products of interest pertaining to those products of a particular business that are offered for sale. For example, a business might sell its products in retail stores (e.g., brick-and-mortar stores) or in online stores, and transaction data for such sales can be stored as transaction data in the transaction database 114. Typically, the particular business offers rebates for the purchase of certain products or combination of products during certain time periods by way of the rebate system 100.

The online rebate processing system 102 also includes rebate eligibility rules 116. The rebate eligibility rules 116 are rules that can be configured so as to control the characteristics of those purchases that are eligible for rebates. For example, the rebate eligibility rules 116 can take into consideration: (i) date of purchase, (ii) particular one or more products being purchased, and/or (iii) manner in which the one or more products are purchased.

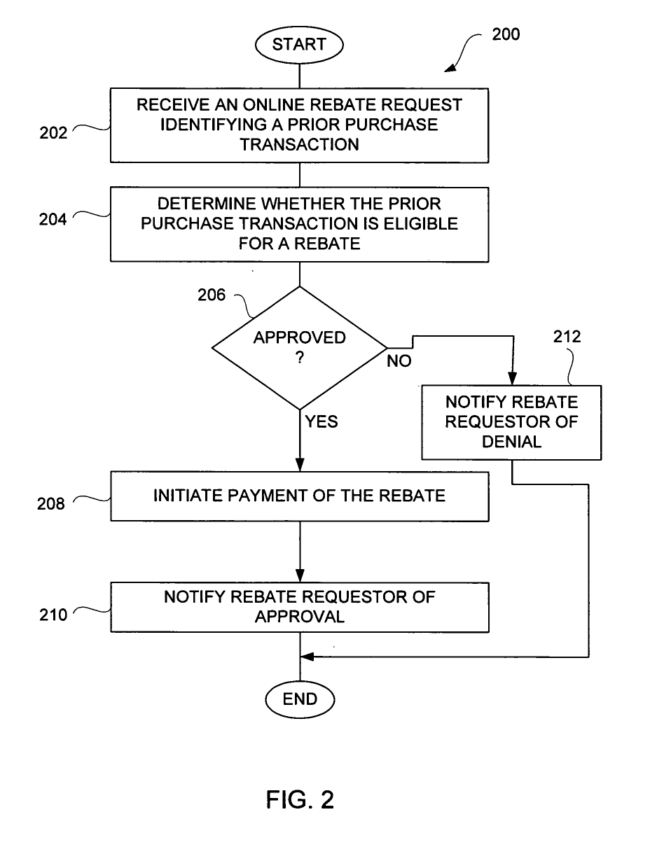

FIG. 2 is a flow diagram of an online rebate process 200 according to one embodiment of the invention. The online rebate process 200 is, for example, performed by the rebate management system 110 illustrated in FIG. 1.

The online rebate process 200 receives an online rebate request from a rebate requester. The rebate requester is ordinarily any prior purchaser of one or more products. The online rebate request identifies a prior purchase transaction. For example, the prior purchase transaction can be identified by a receipt number, an order number or some other identifier. In some cases, the prior purchase transaction is identified by a plurality of data items.

Upon receiving the online rebate request, the online rebate process 200 can determine 204 whether the prior purchase transaction is eligible for a rebate. In one embodiment, the identification of the prior purchase transaction allows the online rebate process 200 to retrieve transaction data associated with the prior purchase. Then, the transaction data associated with the prior purchase can be evaluated to determine 204 whether the prior purchase transaction is eligible for a rebate. In one embodiment, the transaction data associated with the prior purchase can be evaluated in accordance with rebate eligibility rules to determine 204 whether the prior purchase transaction is eligible for a rebate.

Next, a decision 206 determines whether the prior purchase transaction is approved for payment of a rebate. When the decision 206 determines that payment of a rebate is approved for the prior purchase transaction, payment of the rebate can be initiated 208. Next, the rebate requester can be notified 210 of the approval. On the other hand, when the decision 206 determines that the prior purchase transaction is not approved for payment of a rebate, the rebate requester is notified 212 of the denial of the rebate request. Following the block 210 or following the block 212, the online rebate process 200 can end.

When payment of the rebate is initiated 208, payment can be provided to the rebate requester in a variety of different ways depending on implementation and/or system or requestor's preference(s). For example, payment can be provided by (i) mailing a check (or money order or cash) to the rebate requester, (ii) electronic transferring of funds to a financial account associated with the rebate requester, (iii) crediting a credit card associated with the rebate requester, (iv) electronic transferring of funds between accounts using an online payment facilitator (e.g., PayPal™), (v) providing a gift card (physical or electronic) to the rebate requester, (vi) providing a software license key to the rebate requester, (vii) providing a content key or code (e.g., iTunes™ content code) to the rebate requester, (viii) providing a physical product to the rebate requester, or (ix) crediting an online user account (e.g., iTunes™ store credit) associated with the rebate requester. The rebate requester can alternatively designate another to receive the payment of the rebate.

When payment of the rebate is initiated 208, the rebate requester can in one embodiment acquire status of an approved rebate submission. For example, by accessing the web interface 112, the rebate requester can obtain current status of an approved rebate online. As one example, the status could indicate that a rebate is approved, being processed, or payment made.

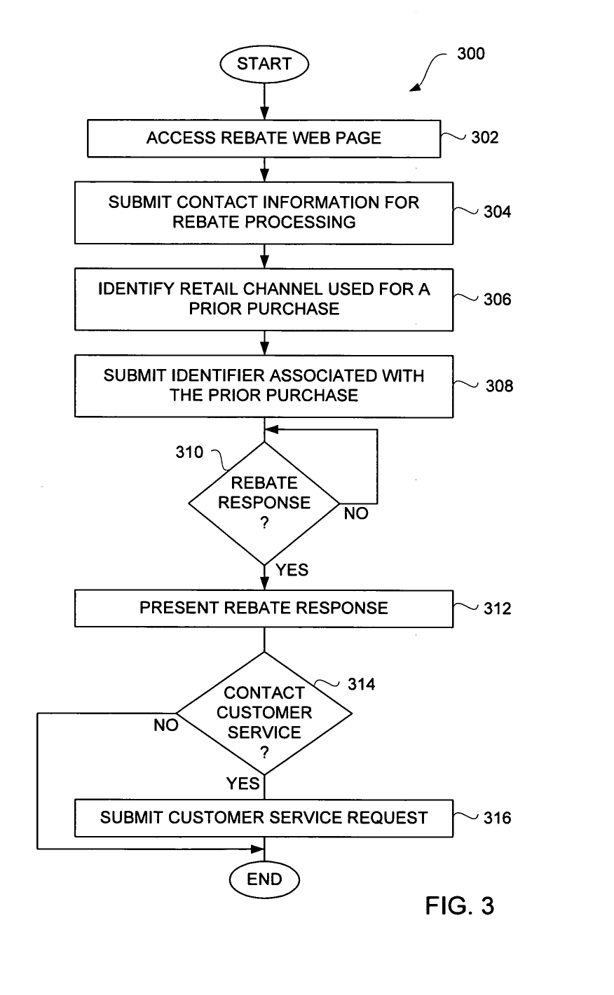

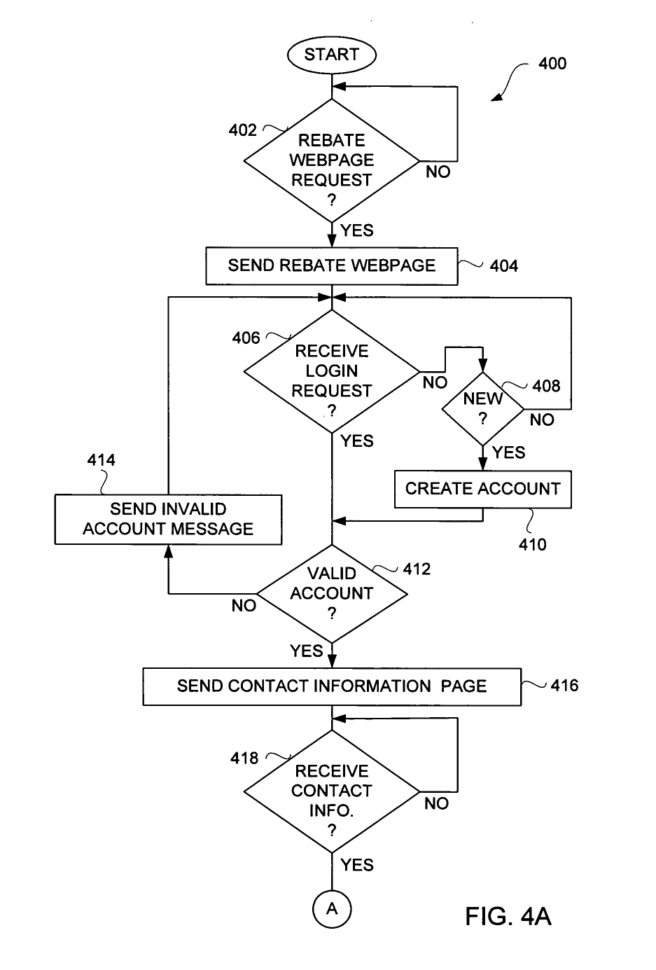

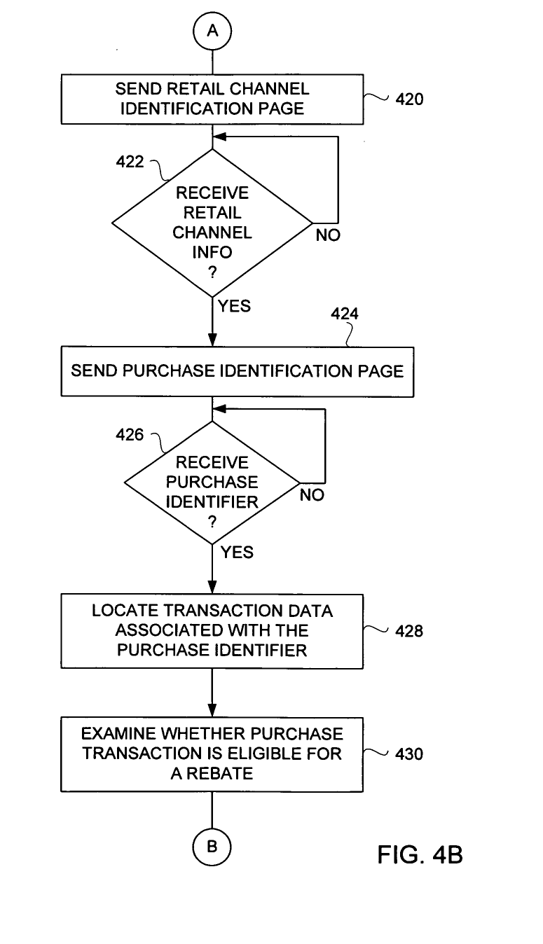

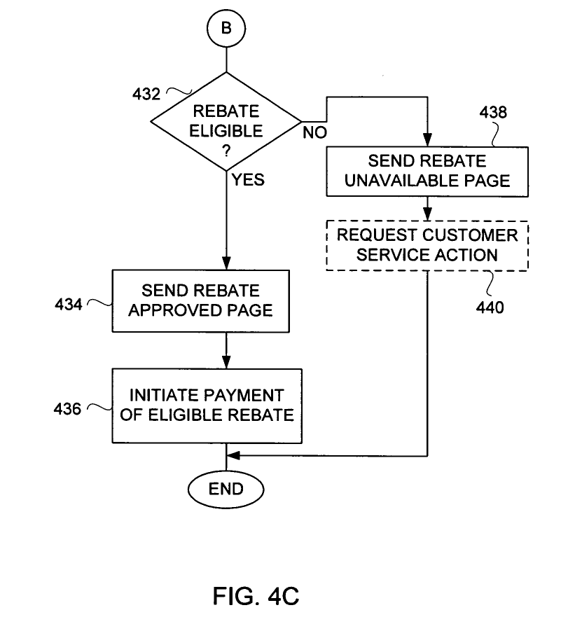

The rebate process according to one aspect of the invention can operate in a client-server environment. FIGS. 3 and 4A-4C illustrates one embodiment of a client-server rebate process. FIG. 3 represents client-side rebate processing according to one embodiment, and FIGS. 4A-4C representing server-side rebate processing according to one embodiment.

FIG. 3 is a flow diagram of a client-side rebate process 300 according to one embodiment of the invention. The client-side rebate process 300 can, for example, be performed by a client machine participating in an online rebate submission. For example, the client machine 106, 108 illustrated in FIG. 1 can operate to perform the client-side rebate process 300.

The client-side rebate process 300 can access 302 a rebate webpage. The rebate webpage can be hosted by an online rebate processing system (e.g., the online rebate processing system 102). For example, a rebate requester can utilize a network browser application operating on the client machine to access a rebate webpage provided via a business to facilitate payment of rebates to those purchasers that have purchased its products.

Next, contact information can be submitted 304 for rebate processing. Here, the rebate requester can interact with the client machine to provide the contact information which is then submitted 304 to the online rebate processing system. In addition, a retail channel used for the prior purchase associated with the rebate requester can be identified 306. Still further, one or more identifiers associated with the prior purchase by the rebate requester can be submitted 308. Here, the one or more identifiers associated with the prior purchase are utilized to locate transaction data stored by the online rebate processing system. For example, the transaction data can be identified by a receipt number, an order number or some other identifier. In some cases, the transaction data is identified by a plurality of data items.

At this point, the online rebate processing system has sufficient information to process the rebate request from the rebate requester. Accordingly, a decision 310 can then determine whether a rebate response has been received from the online rebate processing system. When the decision 310 determines that a rebate response has not yet been received, the client-side rebate process 300 can await such a response. Alternatively, when the decision 310 determines that a rebate response has been received, the client-side rebate process 300 can present 312 the rebate response. For example, the rebate response provided by the online rebate processing system can be displayed at the client machine to the benefit of the rebate requester.

In most cases, the rebate request is a legitimate request and thus the rebate requester is notified by the rebate response that they rebate has been approved for payment. However, in some cases for a variety of different reasons, the rebate request may be denied. In such cases, the rebate requester may desire to contact a customer service representative with regard to the rebate request. Hence, according to one embodiment of the invention, the client-side rebate process 300 can optionally further include a decision 314 that determines whether the requester desires to contact customer service. When the decision 314 determines that the user does desire to contact customer service, a customer service request can be submitted 316. Here, the customer service request can include the information previously provided by the rebate requestor as well as additional information that the rebate requestor can supply to help assist customer service in examining the rebate request. For example, the customer service request can be submitted 316 as an electronic mail message that is sent to an appropriate customer service department at the business.

After the submission 316 of the customer service request, the client-side rebate process 300 can end. Alternatively, when the decision 314 determines that the user does not desire to contact customer service (or automatically when the rebate has been approved), the block 316 can be bypassed such that the client-side rebate process 300 can end.

FIGS. 4A-4C are block diagrams of a server-side rebate process 400 according to one embodiment of the invention. The server-side rebate process 400 can, for example, be performed by a online rebate processing system, such as the online rebate processing system 102 illustrated in FIG. 1. The server-side rebate process 400 can represent counterpart processing to the client-side rebate process 300 discussed above with reference to FIG. 3.

The server-side rebate process 400 can begin with a decision 402 that determines whether a rebate webpage request has been received. For example, the rebate webpage request can be received from a client machine, such as the client machine 106, 108 illustrated in FIG. 1, that performs the client-side rebate process 300 illustrated in FIG. 3. When the decision 402 determines that a rebate webpage request has not been received, the server-side rebate process 400 awaits such a request. Once the decision 402 determines that a rebate webpage request has been received, a rebate webpage can be sent 404 to the client machine.

Next, a decision 406 can determine whether a login request has been received from the client machine. In this embodiment, the online rebate processing system can require that the rebate requester be a registered account holder. The account can be an account specific to the rebate system or a more generally usable account, such as an iTunes™ account, for use with websites or online stores associated (or partnered) with Apple Inc. of Cupertino, Calif. Hence, the decision 406 determines whether a login request has been received. For example, the rebate webpage can request account name and password. When the decision 406 determines that a login request has not yet been received, a decision 408 can determine whether the rebate requester desires to set up a new account. When the decision 408 determines that the rebate requestor does desire to set up a new account, a new account can be created 410. Alternatively, when the decision 408 determines that the rebate requestor does not desire to set up a new account, the server-side rebate process 400 can return to repeat the decision 406. Once the decision 406 determines that a login request has been received, or following the block 410 when a new account has been created, a decision 412 determines whether the login request corresponds to a valid account. When the decision 412 determines that the login request does not correspond to a valid account, an invalid account message can be sent 414 to the client machine, thereby informing the rebate requestor that the login request has been denied. Following the block 414, the client-side rebate process 400 can return to repeat the decision 406.

On the other hand, when the decision 412 determines that the login request corresponds to a valid account, a contact information page can be sent 416 to the client machine. The contact information pages requests that the rebate requestor provide contact information. For example, the contact information can include name, address, telephone, and/or electronic mail address for the rebate requester or other designee. Next, a decision 418 determines whether contact information has been received from the client machine. When the decision 418 determines that contact information has not yet been received, the server-side rebate process 400 can await such information. Once the decision 418 determines that contact information has been received, a retail channel identification page can be sent 420 to the client machine. The retail channel identification page can request retail channel information pertaining to a prior purchase transaction. For example, since the business providing the rebates can sell products in various different retail channels, it is helpful if the rebate requester identifies the particular retail channel in which the purchase occurred. In one implementation, examples of retail channels includes (i) brick-and-mortar stores, (ii) in online stores or (iii) authorized resellers (e.g., authorized campus sales centers).

Next, a decision 422 determines whether retail channel information has been received. When the decision 422 determines that retail channel information has not yet been received, the server-side rebate process 400 awaits such information. Once the decision 422 determines that retail channel information has been received, a purchase identification page can be sent 424 to the client machine. The purchase identification page allows the rebate requester to provide one or more identifiers for the purchase transaction from which a rebate is desired. The one or more identifiers can, for example, include a receipt number, an order number or some other identifier. In some cases, the prior purchase transaction is identified by a plurality of data items. The one or more identifiers for the purchase transaction can also be different depending the retail channel involved. For example, for a retail store purchase, the identifiers to be provided by the rebate requester can include a receipt number, a purchase date and a total purchase price for the receipt. As another example, for an online purchase, the identifier to be provided by the rebate requester can be an order number. The use of multiple identifiers can operate to uniquely identify a particular purchase transaction and/or act as fraud prevention.

Next, a decision 426 can determine whether one or more purchase identifiers have been received from the client machine. When the decision 426 determines that no purchase identifiers have been received, the server-side rebate process 400 can await such information. Alternatively, when the decision 426 determines that one or more purchase identifiers have been received, transaction data associated with the purchase identifier can be located 428. For example, the purchase identifier can be utilized to access a transaction database to extract transaction data that is associated with the purchase identifier. For example, the transaction database can be the transaction database 114 illustrated in FIG. 1. Optionally, the purchaser identifier (or multiple identifiers) can be evaluated to determine if they reference a legitimate purchase transaction. If not, the server-side rebate process 400 can decline further process until a legitimate purchase transaction can be properly identified. If the rebate requester fails a predetermined number of times, the rebate session can be stopped to minimize fraudulent claims. Optionally, further automated rebates on the transaction can be blocked after the predetermined number of failures. The blockage can persist for the session, an hour, a day or indefinitely, unless overridden by a customer service representative. In one implementation, when a rebate is blocked due to such a situation, the last rebate request can be sent to customer service with or without additional comments from the rebate requester (e.g., electronic mail message).

Next, the server-side rebate process 400 can examine 430 whether the purchase transaction that has been identified (located) is eligible for a rebate. A decision 432 can then determined whether the identified purchase transaction is eligible for a rebate. When the decision 432 determines that the identified purchase transaction is eligible for a rebate, a rebate approved page can be sent 434 to the client machine associated with the rebate requester. In one implementation, the rebate approval page is a web page that is sent 434 by the online rebate processing system to the client machine which the web page can be displayed for the rebate requester. In addition, when the particular purchase transaction is determined to be eligible for a rebate, payment for the eligible rebate can be initiated 436.

Alternately, when the decision 432 determines that the identified purchase transaction is not eligible for a rebate, a rebate unavailable page can be sent 438 to the client machine. In this case, the rebate requester can be notified that for any of a number of reasons their rebate request is denied. Optionally, the rebate requester can then request 440 customer service action. As one example, the rebate unavailable page 438 can include a control feature that allows the rebate requestor to send 440 an electronic message to a customer service department of a business to request that they reviewed the denial of the rebate request.

The electronic message can, for example, be pre-populating with information concerning the purchase transaction and may indicate reason for denial. The electronic message can further provide a text entry region where the rebate requestor can enter comments or questions concerning the rebate submission. Following the block 436 or the block 438 (or optionally block 440), the server-side rebate process 410 can end. In one embodiment, the ability to escalate the rebate request to the customer service department can be provided (e.g., with the rebate unavailable page 438) to the rebate requester (block 440). In one implementation, the escalation capability (e.g., escalation path) can be offered when the rebate request is being denied but only if the purchase transaction is determined to be valid. For example, validation of the purchase transaction can involve validation of a purchase identifier.

Consequently, in a manner of several minutes, a rebate requestor can interact with the online rebate processing system and receive a determination as to whether they are eligible for any rebates regarding a particular prior purchase. The rebate requestor can receive a notification that their prior purchase is approved for a rebate and that such rebate amount will be processed for payment. Alternatively, the rebate requester can be notified that for any of a number of reasons their rebate request is denied.

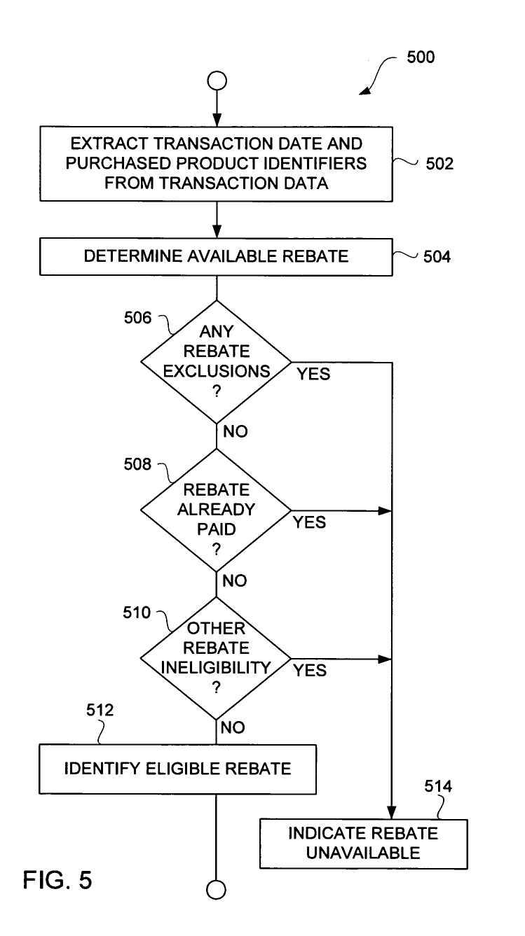

FIG. 5 is a flow diagram of a rebate eligibility process 500 according to one embodiment of the invention. The rebate eligibility process 500 is, for example, processing associated with the block 430 of the server-side rebate process 400 illustrated in FIG. 4B.

The rebate eligibility process 500 can extract 502 a transaction date and one or more purchased product identifiers (e.g., part numbers) from the transaction data. An available rebate can then be determined 504. In one embodiment, the transaction date, purchased product identifiers and potentially other extracted information from the transaction data can be used to evaluate whether a rebate is available. In one embodiment, rebate eligibility rules (or predetermined rebate rules) for rebates can be used to determine whether any of a plurality of potential rebates are available for the particular purchase transaction. In the embodiment illustrated in FIG. 5, it is assumed that at least one rebate is available. However, in general, it may be the case that the transaction data is not eligible to receive any rebates or is eligible for multiple rebates.

After determining the available rebate, a decision 506 can determine whether there is a rebate exclusion. A rebate exclusion can be applied to restrict the available rebates. For example, one rebate exclusion could operate to exclude refurbished products from qualifying for rebates. When decision 506 determines that there is not a rebate exclusion for the available rebate, a decision 508 can determine whether the available rebate has already been paid. A rebate processing can record or access stored data that is descriptive of those rebates already paid. For example, a database can store receipt identifiers and/or part identifiers corresponding to rebates that have been paid. This can prevent double payment of a rebate on a given purchase transaction in the case to erroneous or fraudulent resubmission of a rebate request. When the decision 508 determines that the available rebate has not already been paid, a decision 510 can determine whether there are other reasons that make the available rebate ineligible. When the decision 510 determines that there are no other reasons for ineligibility for the available rebate, an eligible rebate can be identified 512. Here, the available rebate can be deemed an eligible rebate. The eligible rebate can then be processed, such as discussed above with reference to blocks 434 and 436 of the server-side rebate process 400.

Examples of other reasons for ineligibility can vary with implementation. In one embodiment, an available rebate might be deemed ineligible because the purchased products have not yet been shipped to the purchaser (rebate requester). In particular, if all products of the purchase transaction have not yet been shipped, then an otherwise available rebate can bee deemed ineligible (until after all products of the purchase transaction have been shipped). In another embodiment, an available rebate might be deemed ineligible if an account identifier for the rebate requester (e.g., captured at account login, see block 412 of FIG. 4A) does not match an account identifier associated with or part of the transaction data (provided an account identifier is captured at time of purchase).

On the other hand, when the decision 506 determines that a rebate exclusion applies to eliminate the available rebate, then the rebate eligibility process 500 can indicate 514 that there are no rebates available. Also, when the decision 508 determines that the available rebate has already been paid, the rebate eligibility process 500 can also indicate 514 that there are no rebates available. Similarly, when the decision 510 determines that there are other reasons that make the rebate ineligible, the rebate eligibility process 500 can indicate 514 that there are no rebates available. In some cases, there can be an indication as to why no rebates are available. Following the blocks 512 and 514, the rebate eligibility process 500 can end.

According to another aspect of the invention, eligibility of rebates can be determined in a computerized manner in accordance with predetermined eligibility rules. The eligibility rules can implement business rules pertaining to rebates. These rules can be constructed to potentially take into consideration one or more factors. Examples of some factors are: date of purchase, submission date, promotion available date, promotion end date, rebate limit (e.g., maximum number of rebates per purchase transaction), qualifying part numbers, products types (or classes), subclasses, geographic location, retail channel, store type (e.g., online or “brick & mortar”), and particular store. As such, characteristics of rebates being offered can be customized using one or more of the factors. In one embodiment, a rebate configuration tool can be used by an online rebate system to enable a business to configure how, when and for what the business offers rebates. The rebate configuration tool can present a graphical user interface that enables a user to select appropriate factors and ranges, values or conditions for such factors. The rebate configuration tool also permits dynamic changes to the availability and/or characteristics of the rebates.

In one embodiment, payment of rebates can be processed by a third party. In such case, the online rebate system can instruct the third party on what rebates to pay. For example, when the online rebate system initiates payment of a rebate (e.g., block 436 of FIG. 4C), the online rebate system can, in one embodiment, send instruction to a third party payment processor. In one implementation, the online rebate system can send a data feed including all needed information for the third party payment processor to make the rebate payment. In one example, the data feed can be a markup language file (e.g., XML file) that includes tagged data pertaining to the rebates to be paid. In one implementation, the data feed can be provided periodically or on a scheduled basis. To avoid double payment, the third party payment processor can confirm that a payment to the same purchase transaction was not already paid.

Different retail stores may also use different point of sale systems. However, the rebate system can support different point of sale transaction systems. The rebate system supports purchase transactions in retail stores or online stores. Advantageously, the rebate system does not need to assign particular rebate codes at point of sale. Instead, purchase identifier can be used as noted above.

The rebate system also has the flexibility to manage rebate opportunities. For example, rebates are available for certain purchases on certain dates. However, such availability of rebates can be managed or configured to permit changes, retroactivity, and the like. For example, purchases that occur within a “price protection” period can be retroactively validated for rebates associated with such purchases.

The various aspects, embodiments, implementations or features of the invention can be used separately or in any combination.

The invention is preferably implemented by software, hardware, or a combination of hardware and software. The invention can also be embodied as computer readable code on a computer readable medium (or computer readable storage medium). The computer readable medium is any data storage device that can store data which can thereafter be read by a computer system. Examples of the computer readable medium generally include read-only memory and random-access memory. More specific examples of computer readable medium are tangible and include Flash memory, EEPROM memory, memory card, CD-ROM, DVD, hard drive, magnetic tape, and optical data storage device. The computer readable medium can also be distributed over network-coupled computer systems so that the computer readable code is stored and executed in a distributed fashion.

The advantages of the invention are numerous. Different embodiments or implementations may, but need not, yield one or more of the following advantages. One advantage of certain embodiments of the invention is that rebate submission can be performed online and provide near real-time rebate approval or denial. Another advantage of certain embodiments of the invention is that rebates can be processed automatically by computing devices so that purchases can receive immediate feedback. Still another advantage of certain embodiments of the invention is that user experience with rebate submissions that users initiate is dramatically enhanced with an online rebate system. Yet still another advantage of certain embodiment of the invention is that purchases that occur within a “price protection” period can be retroactively validated for rebates associated with such purchases.

The many features and advantages of the present invention are apparent from the written description. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A computer-implemented method for processing rebates, said method comprising:
receiving an online rebate request identifying a prior purchase transaction, the rebate request being associated with a rebate requester;
determining whether the prior purchase transaction is eligible for a rebate; and
notifying the rebate requester that the rebate request has been approved if said determining determines that the prior purchase transaction is eligible for a rebate.

2. A computer-implemented method as recited in claim 1, whereby the rebate requester receives near immediate feedback on whether the rebate request has been approved.

3. A computer-implemented method as recited in claim 1, wherein said determining comprises:
accessing transaction data pertaining to the prior purchase transaction;
comparing the transaction data pertaining to the prior purchase transaction to a plurality of rebate eligibility rules; and
determining at least one eligible rebate for the prior purchase transaction.

4. A computer-implemented method as recited in claim 1, wherein said method further comprises:
initiating payment of the rebate if said determining determines that the prior purchase transaction is eligible for a rebate.

5. A computer-implemented method as recited in claim 4,
wherein the rebate request further provides contact information, and
wherein the payment is directed to the contact information.

6. A computer-implemented method as recited in claim 4, wherein said method further comprises:
marking the prior purchase transaction unavailable for a further rebate if the rebate request has been approved.

7. A computer-implemented method as recited in claim 1, wherein the rebate requester only need make the rebate request online.

8. A computer-implemented method as recited in claim 1, wherein no physical mailing is required from the rebate requester.

9. A computer-implemented method as recited in claim 1, wherein said method further comprising:
receiving an indication of a retail channel used for the prior purchase transaction.

10. A computer-implemented method for electronically processing a rebate claim, said method comprising:
receiving an account login request for a rebate requester operating a client machine;
validating the rebate requester in response to the account login request;
sending a contact information page for display at the client machine, the contact information facilitating acquisition of contact information for use in processing the rebate claim;
sending a retail channel identification page for display at the client machine, the retail channel identification page facilitating acquisition of an indication of a retail channel used in a purchase transition for which a rebate is sought;
sending a purchase identification page for display at the client machine, the purchase identification page facilitating acquisition of at least one purchase identification indicia for the purchase transition for which a rebate is sought;
accessing transaction data associated with the at least one purchase identification indicia for the purchase transaction;
determining whether the purchase transaction is eligible for at least one rebate based on at least the transaction data for the purchase transaction; and
sending a rebate approval page for display at the client machine if said determining determines that the purchase transaction is eligible for at least one rebate.

11. A computer-implemented method as recited in claim 10, wherein said method further comprises:
initiating payment of the at least one rebate if said determining determines that the purchase transaction is eligible for at least one rebate.

12. A computer-implemented method as recited in claim 10, wherein said method further comprises:
sending a rebate unavailable page for display at the client machine if said determining determines that the purchase transaction is ineligible for at least one rebate.

13. A computer-implemented method as recited in claim 10, wherein the at least one purchase identification indicia for the purchase transition acquired by the purchase identification page is dependent on the retail channel used in the purchase transition for which a rebate is sought.

14. A computer-implemented method as recited in claim 10, wherein the at least one purchase identification indicia comprises a receipt number for the purchase transaction.

15. A computer-implemented method as recited in claim 10, wherein the at least one purchase identification indicia comprises a receipt number, a date of purchase and a total receipt amount for the purchase transaction.

16. A computer-implemented method as recited in claim 10, wherein the at least one purchase identification indicia comprises an online order number for the purchase transaction.

17. A computer-implemented method as recited in claim 10, wherein said determining whether the purchase transaction is eligible for at least one rebate comprises:
determining whether all products of the purchase transaction have been shipped; and
determining that no rebate is available on the purchase transaction until after all products of the purchase transaction have been shipped.

18. A computer-implemented method as recited in claim 10, wherein said method further comprises:
providing an escalation path when said determining determines that the purchase transaction is deemed ineligible.

19. An online rebate processing system, comprising:
a web interface configured to permit a purchaser to identify a prior purchase transaction and request a rebate payment;
a transaction database configured to store sales transaction data for products; and
a rebate management system operatively connected to said transaction database and said web interface, said rebate management system being configured to process the request for rebate payment, said rebate management system retrieving corresponding sales transaction data for the prior purchase transaction and thereafter processing the request for rebate payment in accordance with predetermined rebate rules and the retrieved sales transaction data to determine whether the request for rebate payment is approved.

20. An online rebate processing system as recited in claim 19, wherein said online rebate processing system further comprises:
a payment processing system configured to provide rebate payment to those of the requests for rebate payments that are approved.

21. An online rebate processing system as recited in claim 19, wherein said rebate management system checks to see if a rebate payment has already been paid for the prior purchase transaction before approving the request for rebate payment.

22. An online rebate processing system as recited in claim 19,
wherein said online rebate processing system further causes a paid indication to be stored for each of the rebate payments that have been paid or approved for payment, and
wherein, before approving the request for rebate payment, said rebate management system checks whether a paid indication indicates that a rebate payment has already been paid for the prior purchase transaction.

23. An online rebate processing system as recited in claim 19,
wherein said web interface provides a purchase identification page and a contact information page to the purchaser, and wherein said web interface provides a rebate approval page if the request for rebate payment has been approved.

24. An online rebate processing system as recited in claim 19,
wherein said web interface provides a retail channel identification page so that the purchaser can designate a retail channel used for the prior purchase transaction, and
wherein at least one of the predetermined rebate rules used by said rebate management system are different depending on the retail channel used.

25. A computer readable storage medium including at least executable computer program code tangibly stored thereon for processing rebates, said computer readable storage medium comprising:
computer program code for receiving an online rebate request identifying a prior purchase transaction, the rebate request being associated with a rebate requester;
computer program code for determining whether the prior purchase transaction is eligible for a rebate; and
computer program code for notifying the rebate requester that the rebate request has been approved if said determining determines that the prior purchase transaction is eligible for a rebate.

26. A computer readable storage medium as recited in claim 25, wherein said computer readable storage medium further comprises:
computer program code for providing an escalation path when said computer program code for determining determines that the purchase transaction is deemed ineligible.

27. A computer readable storage medium as recited in claim 25, wherein said computer readable storage medium further comprises:
computer program code for determining whether the purchase transaction is valid; and.
computer program code for providing an escalation path when it is determined that the purchase transaction is valid but the purchase transaction is deemed ineligible.
